(19) United States
(12) Patent Application Publication
(10) Pub. No.: US 2022/0327566 A1
(43) Pub. Date: Oct. 13, 2022

(54) SYSTEM FOR INTELLIGENT AND ADAPTIVE REAL TIME VALUATION ENGINE USING LSTM NEURAL NETWORKS AND MULTI VARIANT REGRESSION ANALYSIS

(71) Applicant: BANK OF AMERICA CORPORATION, Charlotte, NC (US)

(72) Inventor: Vinay Laxmikant Bade, Hyderabad (IN)

(73) Assignee: BANK OF AMERICA CORPORATION, Charlotte, NC (US)

(21) Appl. No.: 17/225,618

(22) Filed: Apr. 8, 2021

(51) Int. Cl. G06Q 30/02; G06K 9/62; G06N 3/08

(52) U.S. Cl. CPC G06Q 30/0206; G06K 9/6298; G06N 3/08; G06K 9/6257

(57) ABSTRACT

Embodiments of the present invention provide a system for an intelligent and adaptive real time valuation engine. The described system receives a plurality of input data from data pipelines, the input data including a request for an available transaction value given certain parameters. The system provides the plurality of input data into a long short term memory neural network engine for the identification of dependencies between data characteristics and transaction values, providing a continuous stream of predicted transaction for multiple nodes of the neural network engine. The system then assigns weighting to the outputs of the neural network engine, and determines the available transaction values based on these weighted outputs.

### BACKGROUND

Valuation engines are helpful in providing available valuations for products across multiple markets. However, these markets are becoming highly fragmented, are present across the globe, operate at all hours of the day, and are highly interlinked and correlated in certain aspects. Furthermore, the volume of data associated with these products, their valuations, the markets, and the users is increasing exponentially while the variety and diversity of the types of data recorded and available continues to increase.

Despite the high volume of data to be analyzed and the variety of parameters available to be analyzed in product valuations, users and providing entities require accurate sub-millisecond valuation results to effectively engage in these markets. Therefore, a need exists to provide a system for an intelligent and adaptive real time valuation engine using long short term memory (“LSTM”) neural networks and multi variant regression analysis.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for an intelligent and adaptive real time valuation engine. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The system may involve receiving a plurality of input data from data pipelines in real time, including a request for an available transaction value given a specific set of transaction parameters provided by a user from a computing device of the user. In some embodiments, the plurality of input data includes market values of current and historical equity values, currency values, interest rate values, and stock indices values. Additionally or alternatively, the plurality of input data includes macroeconomic factors or indicators of employment values, and industrial values. Furthermore, in some embodiments, the plurality of input data includes user information including historical transactions associated with the user.

In some embodiments, the system provides the plurality of input data to a long short term memory neural network engine comprising multiple nodes configured to identify long term dependencies between data characteristics and transaction values and output a continuous time series of predicted transaction values for each node of the long short term memory neural network engine. With respect to the data pipelines, in some embodiments, at least a portion of the plurality of input data received from data pipelines is received from continuous data streaming channels.

Additionally, in some embodiments, the system receives, from the long short term memory neural network engine, the continuous time series of predicted transaction values for each of the multiple nodes. In some embodiments where the input data is received via continuous data streaming channels, the system may determine one or more of the multiple nodes of the long short term memory neural network engine associated with each item of input data received from the continuous data streaming channels, based on a data source or a data characteristic. In such embodiments, the system may transmit each item of input data received from the continuous data streaming channels to the associated one or more of the multiple nodes of the long short term memory neural network engine.

The system may also assign dynamic weighting to each predicted transaction value for each of the multiple nodes. In some embodiments, the step of assigning dynamic weighting to each predicted transaction value for each of the multiple nodes comprises determining a correlated weighting value based on the extent that the particular type of input data associated with each node influences the predicted transaction value.

Finally, in some embodiments, the system determines the available transaction value given the specific set of transaction parameters through multivariate regression analysis based on the continuous time series of predicted transaction values for each of the multiple nodes and the assigned dynamic weighting.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for an intelligent and adaptive real time valuation engine, in accordance with an embodiment of the invention;

FIG. 2 provides a block diagram illustrating the managing entity system of FIG. 1, in accordance with an embodiment of the invention;

FIG. 3 provides a block diagram illustrating the computing device system of FIG. 1, in accordance with an embodiment of the invention;

FIG. 4 provides a process flow diagram illustrating the system for an intelligent and adaptive real time valuation engine, in accordance with an embodiment of the invention; and

FIG. 5 provides a flowchart illustrating a process for an intelligent and adaptive real time valuation engine, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

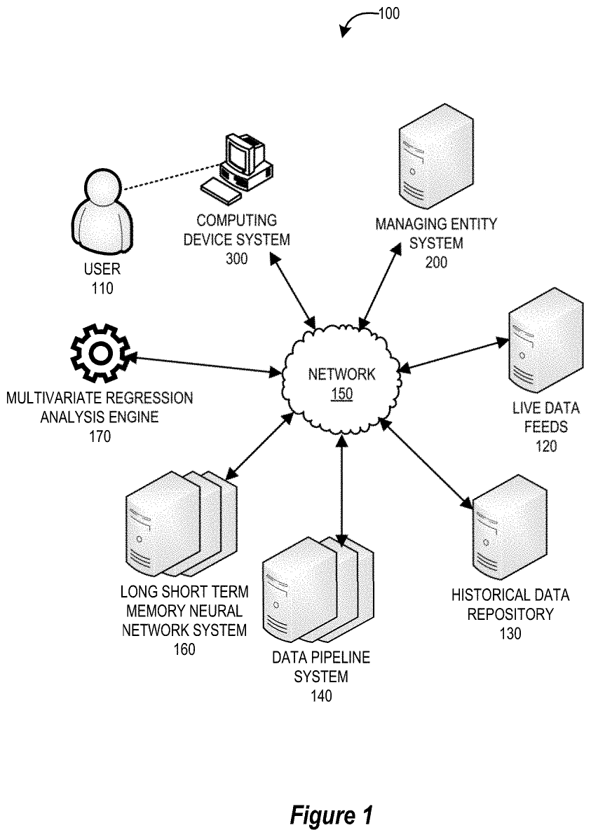

FIG. 1 provides a block diagram illustrating a system environment 100 for an intelligent and adaptive real time valuation engine, in accordance with an embodiment of the invention. As illustrated in FIG. 1, the system environment 100 includes a managing entity system 200, one or more computing devices 300 associated with users 110 (e.g., customers of the managing entity associated with the managing entity system 200), live data feeds 120, historical data repositories 130, a data pipeline system 140, a long short term memory neural network system 160, and a multivariate regression analysis engine 170.

The user 110 represents a customer of the managing entity system that controls or owns the managing entity system 200. A user of the system may be a person, but may also be a business (e.g., a merchant) or any other entity. As used herein, the term “user” shall generally mean a person or entity that is requesting a valuation, quotation, price, or other valuation information for a product or market item from the managing entity.

The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In one embodiment, the network 150 includes a wireless telephone network.

In some embodiments of the invention, at least a portion of the live data feeds 120, the historical data repositories 130, and/or the data pipeline system 140 are configured to be controlled and managed by one or more third-party data providers (not shown), financial institutions or other entities over the network 150. In other embodiments, at least a portion of the live data feeds 120, the historical data repositories 130, and/or the data pipeline system 140 are configured to be controlled and managed over the network 150 by the same entity that maintains the managing entity system 300.

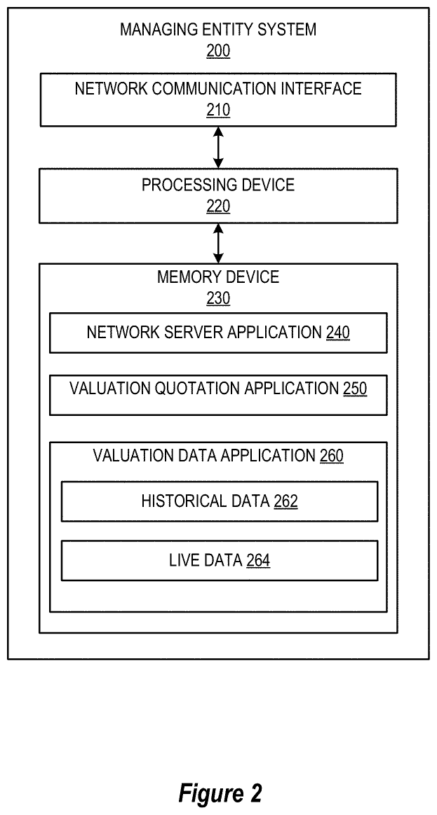

FIG. 2 provides a block diagram illustrating the managing entity system 200, in greater detail, in accordance with embodiments of the invention. As illustrated in FIG. 2, in one embodiment of the invention, the managing entity system 200 includes one or more processing devices 220 operatively coupled to a network communication interface 210 and a memory device 230. In certain embodiments, the managing entity system 200 is operated by a first entity, such as a financial institution, while in other embodiments, the managing entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the managing entity system 200 described herein. For example, in one embodiment of the managing entity system 200, the memory device 230 includes, but is not limited to, a network server application 240, a valuation quotation application 250, a valuation data application 260 which includes historical data 262 and live data 264, and other computer-executable instructions or other data. The computer-executable program code of the network server application 240, the valuation quotation application 250, and/or the valuation data application 260 may instruct the processing device 220 to perform certain logic, data-processing, and data-storing functions of the managing entity system 200 described herein, as well as communication functions of the managing entity system 200.

In one embodiment, the valuation data application 260 includes historical data 262. Additionally, the valuation data application 260 includes live data 264.

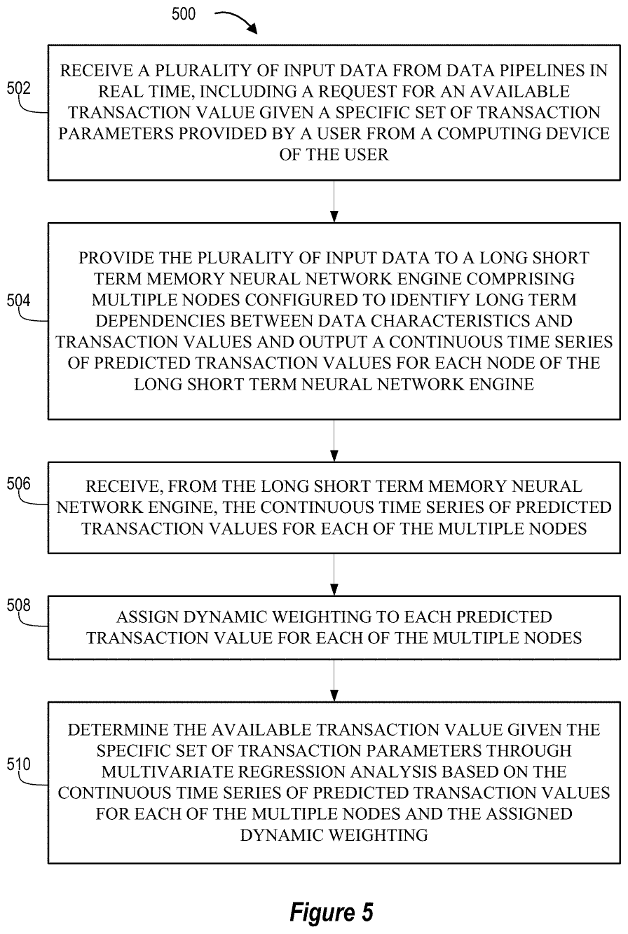

The network server application 240, the valuation quotation application 250, and/or the valuation data application are configured to invoke or use the historical data 252, the live data 254, data from the live data feeds 120, data from the historical data repository 130, data from the data pipeline system 140, and the like to execute one or more process steps described herein, including the steps described in the process flow 500 described in FIG. 5.

As used herein, a “communication interface” generally includes a modem, server, transceiver, and/or other device for communicating with other devices on a network, and/or a user interface for communicating with one or more customers. The network communication interface 210 is a communication interface having one or more communication devices configured to communicate with one or more other devices on the network 150, such as the computing device systems 300, the live data feeds 120, the historical data repository 130, the data pipeline system 140, the long short term memory neural network system 160, the multivariate regression analysis engine 170, and the like. The processing device 220 is configured to use the network communication interface 210 to transmit and/or receive data and/or commands to and/or from the other devices connected to the network 150.

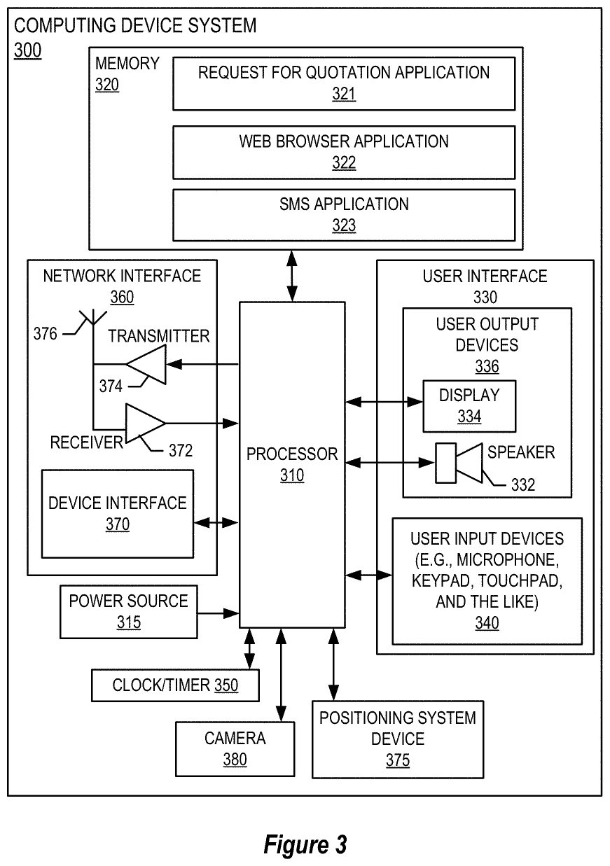

FIG. 3 provides a block diagram illustrating a mobile device system 300 of FIG. 1 in more detail, in accordance with embodiments of the invention. In one embodiment of the invention, the mobile device system 300 is a mobile telephone. However, it should be understood that a mobile telephone is merely illustrative of one type of mobile device system 300 that may benefit from, employ, or otherwise be involved with embodiments of the present invention and, therefore, should not be taken to limit the scope of embodiments of the present invention. Other types of mobile devices 300 may include portable digital assistants (PDAs), pagers, mobile televisions, gaming devices, laptop computers, cameras, video recorders, audio/video player, radio, GPS devices, or any combination of the aforementioned.

Some embodiments of the mobile device system 300 include a processor 310 communicably coupled to such devices as a memory 320, user output devices 336, user input devices 340, a network interface 360, a power source 315, a clock or other timer 350, a camera 380, and a positioning system device 375. The processor 310, and other processors described herein, generally include circuitry for implementing communication and/or logic functions of the mobile device system 300. For example, the processor 310 may include a digital signal processor device, a microprocessor device, and various analog to digital converters, digital to analog converters, and/or other support circuits. Control and signal processing functions of the mobile device system 300 are allocated between these devices according to their respective capabilities. The processor 310 thus may also include the functionality to encode and interleave messages and data prior to modulation and transmission. The processor 310 can additionally include an internal data modem. Further, the processor 310 may include functionality to operate one or more software programs, which may be stored in the memory 320. For example, the processor 310 may be capable of operating a connectivity program, such as a web browser application 322. The web browser application 322 may then allow the mobile device system 300 to transmit and receive web content, such as, for example, location-based content and/or other web page content, according to a Wireless Application Protocol (WAP), Hypertext Transfer Protocol (HTTP), and/or the like.

The processor 310 is configured to use the network interface 360 to communicate with one or more other devices on the network 150. In this regard, the network interface 360 includes an antenna 376 operatively coupled to a transmitter 374 and a receiver 372 (together a “transceiver”). The processor 310 is configured to provide signals to and receive signals from the transmitter 374 and receiver 372, respectively. The signals may include signaling information in accordance with the air interface standard of the applicable cellular system of a wireless network. In this regard, the mobile device system 300 may be configured to operate with one or more air interface standards, communication protocols, modulation types, and access types. By way of illustration, the mobile device system 300 may be configured to operate in accordance with any of a number of first, second, third, and/or fourth-generation communication protocols and/or the like. For example, the mobile device system 300 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 3GPP protocols and/or the like. The mobile device system 300 may also be configured to operate in accordance with non-cellular communication mechanisms, such as via a wireless local area network (WLAN) or other communication/data networks.

As described above, the mobile device system 300 has a user interface that is, like other user interfaces described herein, made up of user output devices 336 and/or user input devices 340. The user output devices 336 include a display 330 (e.g., a liquid crystal display or the like) and a speaker 332 or other audio device, which are operatively coupled to the processor 310.

The user input devices 340, which allow the mobile device system 300 to receive data from a user such as the user 110, may include any of a number of devices allowing the mobile device system 300 to receive data from the user 110, such as a keypad, keyboard, touch-screen, touchpad, microphone, mouse, joystick, other pointer device, button, soft key, and/or other input device(s). The user interface may also include a camera 380, such as a digital camera.

The mobile device system 300 may also include a positioning system device 375 that is configured to be used by a positioning system to determine a location of the mobile device system 300. For example, the positioning system device 375 may include a GPS transceiver. In some embodiments, the positioning system device 375 is at least partially made up of the antenna 376, transmitter 374, and receiver 372 described above. For example, in one embodiment, triangulation of cellular signals may be used to identify the approximate or exact geographical location of the mobile device system 300. In other embodiments, the positioning system device 375 includes a proximity sensor or transmitter, such as an RFID tag, that can sense or be sensed by devices known to be located proximate a merchant or other location to determine that the mobile device system 300 is located proximate these known devices.

The mobile device system 300 further includes a power source 315, such as a battery, for powering various circuits and other devices that are used to operate the mobile device system 300. Embodiments of the mobile device system 300 may also include a clock or other timer 350 configured to determine and, in some cases, communicate actual or relative time to the processor 310 or one or more other devices.

The mobile device system 300 also includes a memory 320 operatively coupled to the processor 310. As used herein, memory includes any computer readable medium (as defined herein below) configured to store data, code, or other information. The memory 320 may include volatile memory, such as volatile Random Access Memory (RAM) including a cache area for the temporary storage of data. The memory 320 may also include non-volatile memory, which can be embedded and/or may be removable. The non-volatile memory can additionally or alternatively include an electrically erasable programmable read-only memory (EEPROM), flash memory or the like.

The memory 320 can store any of a number of applications which comprise computer-executable instructions/code executed by the processor 310 to implement the functions of the mobile device system 300 and/or one or more of the process/method steps described herein. For example, the memory 320 may include such applications as a conventional web browser application 322 and/or a request for quotation application 321 (or any other application provided by the managing entity system 200). These applications also typically instructions to a graphical user interface (GUI) on the display 330 that allows the user 110 to interact with the mobile device system 300, the managing entity system 200, and/or other devices or systems. In other embodiments of the invention, the user 110 interacts with the managing entity system 200 or the resource accumulation system 400 via the web browser application 322 in addition to, or instead of, the request for quotation application 321.

The memory 320 of the mobile device system 300 may comprise a Short Message Service (SMS) application 323 configured to send, receive, and store data, information, communications, alerts, and the like via the wireless telephone network 152.

The memory 320 can also store any of a number of pieces of information, and data, used by the mobile device system 300 and the applications and devices that make up the mobile device system 300 or are in communication with the mobile device system 300 to implement the functions of the mobile device system 300 and/or the other systems described herein. For example, the memory 320 may include such data as historical transactions, historical quotation valuations for products or other market items, and the like.

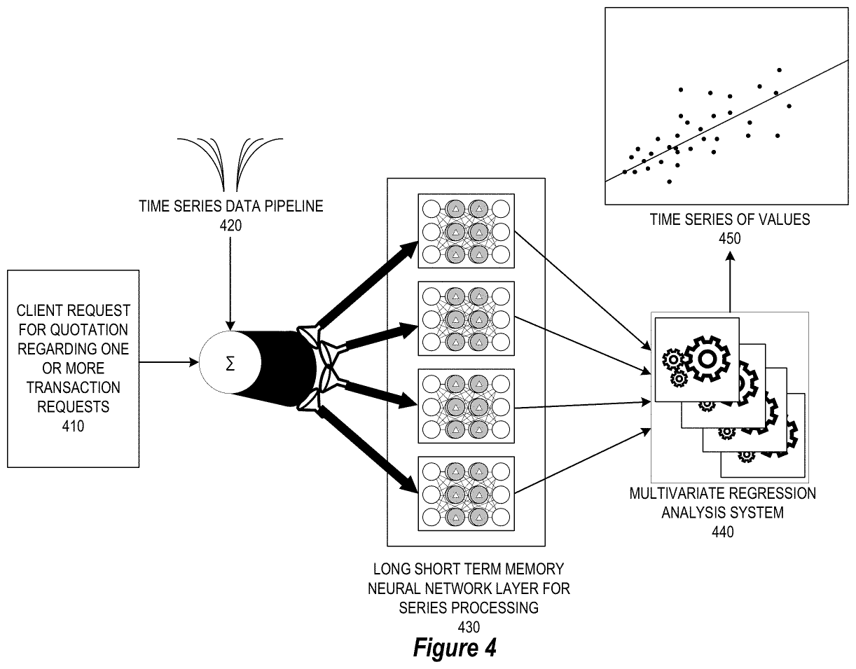

Referring now to FIG. 4, a process flow diagram 400 of one or more embodiments of the invention is illustrated. As illustrated in FIG. 4, the system receives a request for quotation regarding one or more transaction requests, as shown in block 410. This request for quotation is transmitted to certain nodes of the long short term memory neural network layer for series processing, as shown in block 430. The long short term memory neural network additionally receives or extracts data from the time series data pipeline, as shown in block 420.

In some embodiments, the client request for quotation is also received via a time series data pipeline 420. The time series data pipeline 420 may be a high throughput data transfer solution that is capable of acquiring or receiving large amounts of data that is not necessarily of a similar format, and transferring that data to the LSTM neural network layer for series processing 430. The time series data pipeline may comprise components including one or more of a live data feed 120, historical data repository, and the data pipeline system 140 of FIG. 1. Examples of input data include, but are not limited to, market data inputs like equity prices, currencies prices, interest rates, stock indices, and historical quotes, and financial transactions (e.g., trades, loans, deposits, portfolio trading, and the like). Additionally, the data inputs may include items like macro economic factors and indicators, employment data, and industrial numbers.

The individual data elements received from the time series data pipeline 420 and/or the client request for quotation (see block 410) can cover a wide variety of information types, and can be voluminous. To manage the variety and volume of input data, the system may identify one or more types of data or information that each data element represents. The system can then feed each node of the LSTM neural network layer for series processing element 430 with data that is of a type that is relevant to the particular node. For example, one node of the LSTM neural network (see block 430) may be configured to analyze market parameters. In such a scenario, the system may provide to this market parameters node all data elements that are of data types that relate to market parameters including, but not limited to, currency prices, equity prices, market macro factors, and the like. Similarly, if a different node of the LSTM neural network is configured to analyze client parameters, the system may provide to this client parameters node all data elements that are of data types that relate to client parameters including, but not limited to, client trades, historical client trading patterns, client tolerance metrics, portfolio tolerance levels, and the like.

Examples of the parameters that one or more nodes of the LSTM neural network may analyze include, but are not limited to, market parameters, client parameters, macro-economic parameters, trading and sales parameters, counterparty related valuation spreads, historical quotations for various types of transactions, current positions and tolerance metrics, current and historical market driven parameters like indices, and market current pricing trends.

The benefits of using the LSTM neural network with various nodes that are configured to analyze specific parameters is that the LSTM neural network is able to identify long term dependencies between various parameters. LSTM neural networks are designed to store and utilize these input data parameters for a long duration of time, and therefore are able to analyze large amounts of data over long periods of time, even as at least some of the data is received as a continuous stream. In some embodiments, the LSTM analysis is based on the equation “fₜ=σ(W_{f}[hₜ₋₁,xₜ]+b_{f})”.

The outputs of the LSTM neural networks are then fed into the multivariate regression analysis system, as shown in block 440. The multivariate regression analysis, a supervised learning algorithm, uses the multiple input parameters from the LSTM neural network layer for series processing 430 as decision making parameters for the value being predicted. In some embodiments, these inputs derived from the LSTM neural network are assigned dynamic weights. The interpretation of the multivariate regression model provides the impact of each independent variable on the dependent variable (e.g., the historical client transactions and tolerance level of the client) and are assigned weightage on how much they influence the quoted transaction value for a specific client request for quotation for a transaction. In some embodiments, the multivariate regression analysis is based on the equation “y=b1x1+b2x2+ . . . +bnxn+c”.

The outputs from the LSTM neural networks are streaming continuous time series of predictive values for each of the node of the LSTM neural networks (e.g., parameters like the following: counterparty related pricing spreads, historical quotes for various types of transactions; historical and past financial firm transactions like equities, current positions, and tolerance metrics; and current and historical market driven parameters like indices, market current pricing trends, and macro economic factors).

The multivariate regression analysis system then provides an output of a time series of request for quotation values for each transaction request, as illustrated in block 450. Ultimately, a continuous stream of quotation values are provided to the client (or a user associated with the client), e.g., on a computing device system of a user.

In some embodiments, the output of a time series of request for quotation values for each transaction request can be extended further for deriving business intelligence driven out of statistical modelling and used for management information system, business data analytics, client and trading predictive models, and more use cases. This can be extended further by deploying machine learning based predictive analytics for a client trading pattern.

Referring now to FIG. 5, a flowchart is provided to illustrate one embodiment of a process 500 for an intelligent and adaptive real time valuation engine, in accordance with embodiments of the invention. In some embodiments, the process 500 may include block 502, where the system receives a plurality of input data from data pipelines in real time, including a request for an available transaction value given a specific set of transaction parameters provided by a user from a computing device of the user.

In some embodiments, the plurality of input data includes market values of current and historical equity values, currency values, interest rate values, and stock indices values.

Additionally or alternatively, the plurality of input data includes macroeconomic factors or indicators of employment values, and industrial values.

Furthermore, in some embodiments, the plurality of input data includes user information including historical transactions associated with the user.

In some embodiments, the process 500 includes block 504, where the system provides the plurality of input data to a long short term memory neural network engine comprising multiple nodes configured to identify long term dependencies between data characteristics and transaction values and output a continuous time series of predicted transaction values for each node of the long short term memory neural network engine.

With respect to the data pipelines, in some embodiments, at least a portion of the plurality of input data received from data pipelines is received from continuous data streaming channels.

Additionally, in some embodiments, the process 500 includes block 506, where the system receives, from the long short term memory neural network engine, the continuous time series of predicted transaction values for each of the multiple nodes.

In some embodiments where the input data is received via continuous data streaming channels, the system may determine one or more of the multiple nodes of the long short term memory neural network engine associated with each item of input data received from the continuous data streaming channels, based on a data source or a data characteristic. In such embodiments, the system may transmit each item of input data received from the continuous data streaming channels to the associated one or more of the multiple nodes of the long short term memory neural network engine.

The process 500 may also include block 508, where the system assigns dynamic weighting to each predicted transaction value for each of the multiple nodes.

In some embodiments, the step of assigning dynamic weighting to each predicted transaction value for each of the multiple nodes comprises determining a correlated weighting value based on the extent that the particular type of input data associated with each node influences the predicted transaction value.

Finally, in some embodiments, the process 500 includes block 510, where the system determines the available transaction value given the specific set of transaction parameters through multivariate regression analysis based on the continuous time series of predicted transaction values for each of the multiple nodes and the assigned dynamic weighting.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for an intelligent and adaptive real time valuation engine, the system comprising:
a memory device; and
a processing device operatively coupled to the memory device, wherein the processing device executes computer-readable program code to:
receive a plurality of input data from data pipelines in real time, including a request for an available transaction value given a specific set of transaction parameters provided by a user from a computing device of the user;
provide the plurality of input data to a long short term memory neural network engine comprising multiple nodes configured to identify long term dependencies between data characteristics and transaction values and output a continuous time series of predicted transaction values for each node of the long short term neural network engine;
receive, from the long short term memory neural network engine, the continuous time series of predicted transaction values for each of the multiple nodes;
assign dynamic weighting to each predicted transaction value for each of the multiple nodes; and
determine the available transaction value given the specific set of transaction parameters through multivariate regression analysis based on the continuous time series of predicted transaction values for each of the multiple nodes and the assigned dynamic weighting.

2. The system of claim 1, wherein assigning dynamic weighting to each predicted transaction value for each of the multiple nodes comprises determining a correlated weighting value based on the extent that the particular type of input data associated with each node influences the predicted transaction value.

3. The system of claim 1, wherein the plurality of input data includes market values of current and historical equity values, currency values, interest rate values, and stock indices values.

4. The system of claim 1, wherein the plurality of input data includes macroeconomic factors or indicators of employment values, and industrial values.

5. The system of claim 1, wherein the plurality of input data includes user information including historical transactions associated with the user.

6. The system of claim 1, wherein at least a portion of the plurality of input data received from data pipelines is received from continuous data streaming channels; and wherein the processing device is further configured to execute the computer-readable program code to:
determine one or more of the multiple nodes of the long short term memory neural network engine associated with each item of input data received from the continuous data streaming channels, based on a data source or a data characteristic.

7. The system of claim 6, wherein the processing device is further configured to execute the computer-readable program code to transmit each item of input data received from the continuous data streaming channels to the associated one or more of the multiple nodes of the long short term memory neural network engine.

8. A computer program product for an intelligent and adaptive real time valuation engine, the computer program product comprising at least one non-transitory computer readable medium comprising computer readable instructions, the instructions comprising instructions for:
receiving a plurality of input data from data pipelines in real time, including a request for an available transaction value given a specific set of transaction parameters provided by a user from a computing device of the user;
providing the plurality of input data to a long short term memory neural network engine comprising multiple nodes configured to identify long term dependencies between data characteristics and transaction values and output a continuous time series of predicted transaction values for each node of the long short term neural network engine;
receiving, from the long short term memory neural network engine, the continuous time series of predicted transaction values for each of the multiple nodes;
assigning dynamic weighting to each predicted transaction value for each of the multiple nodes; and
determining the available transaction value given the specific set of transaction parameters through multivariate regression analysis based on the continuous time series of predicted transaction values for each of the multiple nodes and the assigned dynamic weighting.

9. The computer program product of claim 8, wherein assigning dynamic weighting to each predicted transaction value for each of the multiple nodes comprises determining a correlated weighting value based on the extent that the particular type of input data associated with each node influences the predicted transaction value.

10. The computer program product of claim 8, wherein the plurality of input data includes market values of current and historical equity values, currency values, interest rate values, and stock indices values.

11. The computer program product of claim 8, wherein the plurality of input data includes macroeconomic factors or indicators of employment values, and industrial values.

12. The computer program product of claim 8, wherein the plurality of input data includes user information including historical transactions associated with the user.

13. The computer program product of claim 8, wherein at least a portion of the plurality of input data received from data pipelines is received from continuous data streaming channels; and wherein the computer readable instructions further comprise instructions for:
determining one or more of the multiple nodes of the long short term memory neural network engine associated with each item of input data received from the continuous data streaming channels, based on a data source or a data characteristic.

14. The computer program product of claim 13, wherein the processing device is further configured to execute the computer-readable program code to transmit each item of input data received from the continuous data streaming channels to the associated one or more of the multiple nodes of the long short term memory neural network engine.

15. A computer implemented method for an intelligent and adaptive real time valuation engine, said computer implemented method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving a plurality of input data from data pipelines in real time, including a request for an available transaction value given a specific set of transaction parameters provided by a user from a computing device of the user;
providing the plurality of input data to a long short term memory neural network engine comprising multiple nodes configured to identify long term dependencies between data characteristics and transaction values and output a continuous time series of predicted transaction values for each node of the long short term neural network engine;
receiving, from the long short term memory neural network engine, the continuous time series of predicted transaction values for each of the multiple nodes;
assigning dynamic weighting to each predicted transaction value for each of the multiple nodes; and
determining the available transaction value given the specific set of transaction parameters through multivariate regression analysis based on the continuous time series of predicted transaction values for each of the multiple nodes and the assigned dynamic weighting.

16. The computer implemented method of claim 15, wherein assigning dynamic weighting to each predicted transaction value for each of the multiple nodes comprises determining a correlated weighting value based on the extent that the particular type of input data associated with each node influences the predicted transaction value.

17. The computer implemented method of claim 15, wherein the plurality of input data includes market values of current and historical equity values, currency values, interest rate values, and stock indices values.

18. The computer implemented method of claim 15, wherein the plurality of input data includes macroeconomic factors or indicators of employment values, and industrial values.

19. The computer implemented method of claim 15, wherein the plurality of input data includes user information including historical transactions associated with the user.

20. The computer implemented method of claim 15, wherein at least a portion of the plurality of input data received from data pipelines is received from continuous data streaming channels; and wherein the computer implemented method further comprises:
determining one or more of the multiple nodes of the long short term memory neural network engine associated with each item of input data received from the continuous data streaming channels, based on a data source or a data characteristic; and
transmitting each item of input data received from the continuous data streaming channels to the associated one or more of the multiple nodes of the long short term memory neural network engine.
